(19) United States
(12) Patent Application Publication
(10) Pub. No.: US 2009/0031867 A1
(43) Pub. Date: Feb. 5, 2009

(54) MULTI-FUNCTION SCREWDRIVER

(76) Inventors: Ronald Andronica, Brooklyn, NY (US); Randall C. Andronica, Brooklyn, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 12/250,984

(22) Filed: Oct. 14, 2008

Related U.S. Application Data
(63) Continuation-in-part of application No. 11/581,290, filed on Oct. 16, 2006.
(60) Provisional application No. 60/727,083, filed on Oct. 17, 2005.

(51) Int. Cl. B25B 15/00; B25B 23/00; B25B 15/04

(52) U.S. Cl. 81/436; 81/177.1; 81/60

(57) ABSTRACT

A screwdriver has an elongate handle generally defining an axis and a substantially uniform elongate shank arranged along the axis. One end of the shank is embedded within the handle and defines a cylindrical surface and having another end provided with a driver tip arranged within a cylindrical envelope defined by the cylindrical surface and is configured for engaging and driving a fastener by rotating the fastener about an axis substantially coextensive with the handle axis. An auxiliary driver means is arranged within the cylindrical envelope for driving a fastener about an axis substantially normal to the handle axis.

### CROSS REFERENCE TO RELATED APPLICATION

This application is related to and claims priority of Provisional Application Ser. No. 60/727,083 filed on Oct. 17, 2005 and a CIP of U.S. patent application Ser. No. 11/581,290 filed on Oct. 16, 2006.

### BACKGROUND OF THE INVENTION

1. Field of the Invention

This invention generally relates to hand tools, and, more specifically, to multi-function screwdrivers.

2. Description of the Prior Art

Troy U.S. Pat. No. 366,439 appears to be the father of auxiliary drive screwdrivers. He teaches raised ribs disposed at 90 degrees to each other on either side of the screwdriver blade. He also teaches the use of a reversible ratchet in the tool handle. Our invention discloses a relieved rib that can engage a fastener on the tip of the tool and a Torrington slip roller clutch in the handle instead of a ratchet tooth and pawl mechanism. Shay U.S. Pat. No. 1,239,131 and Tomelick U.S. Pat. No. 1,728,141 disclose enlarged head screwdrivers with a plurality of ribs to turn a screw in areas of limited swing. Shay's tool can turn a fastener with as little as 45 degrees of arc. These tools are costly to manufacture, cannot be used in a counter-bored hole, are limited to slotted screws, and have a limited ability to renew the tool. We disclose an insert bit driver in the screwdriver blade which may employ any style bit, is less expensive to manufacture, and can turn a screw with 30 degrees of arc, and can be used in a counter-bored hole.

Berquist, U.S. Pat. No. 724,154, Velepec, U.S. Pat. No. 2,141,072, Tascone, U.S. Pat. No. 3,842,875 and Cournoyer, U.S. Pat. No. 4,158,375 all disclose low profile auxiliary drive screwdrivers. Berquist did not propose this use, but this is possible if dimensioned properly. Berquist, and Tascone's auxiliary drivers are limited to slotted style screws and could not be used with countersunk flat head screws. Tascone's tool would be difficult to recondition if worn or damaged, and/or would have reduced engagement with the screw head that can strip the screw.

Velepec features a truncated point auxiliary driver which could possibly be used on flat head screws with sufficient overhead clearance. Because of the reduced contact area of the tool with slot, the tool would likely strip a screw when used as a conventional screwdriver. Renewing a worn tool would be difficult.

Cournoyer teaches fixed auxiliary drivers for slotted screws and a sliding head embodiment that can employ other style drivers. The sliding head cannot be positioned in close proximity with the tip of the tool, which limits its ability to get at a screw in a corner. Additionally, the ability to renew a worn or damaged driver is difficult, impossible, or limited at best. Our auxiliary, bit in the blade, driver utilizes disposable bits, and can access a screw close to a corner.

Clearly, the field of auxiliary drive screwdrivers is a crowed art. Despite all the prior art the auxiliary relieved rib is structurally unlike all others. It also has benefits the others do not; such as, a simpler design which is easier to manufacture and hence lower cost. Furthermore, existing screwdrivers may be modified to incorporate the Sidewinder™ feature with a simple machining operation.

The prior art also does not teach the use of a fixed bit driver in either the handle or the screwdriver blade.

Hull's U.S. Pat. No. 5,210,895 is for a combined file and screwdriver like one of the embodiments of our invention. Hull claims removable shank members. The retention means is not supported by the drawing and text. The problem with removable shanks in this application, is that the shank will pull out from the handle in use (on the backstroke), and if secured by threads, will unscrew when used as a screwdriver. The current invention utilizes a fixed shank and a combination auxiliary driving tip.

Hadfield's U.S. Pat. No. 2,609,851 is for a fixed sleeve over the shank to facilitate turning the screw at a higher rate of speed. The current invention uses a removable sleeve for protection from the file teeth and electricity. A removable sleeve is necessary in order to use the file shank. There was no reason for Hadfield to utilize a removable sleeve as the shank of his tool does not have an auxiliary function.

Clark, U.S. Pat. No. 2,550,775 teaches the use of a bar magnet to secure bits in a screwdriver shank or extension. Several embodiments of our invention utilize the teaching of Clark except we employ rare earth disc magnets. Additionally, we extended the use to hold a shank or driver to the tool handle as well.

Smith, U.S. Pat. No. 4,356,852 teaches a hand tool with a well and a hexagonal shaft to receive a socket wrench driver to transmit additional torque to the screwdriver. An embodiment of our invention employs this arrangement. The distinction over Smith and the current invention is that all the elements for producing additional torque may be self contained in the tool and the stubby drive element is retained magnetically and is itself multifunctional.

Stubby screwdrivers are well known in the art and commercially available units with magnetic bit retention are available from Harbor Freight Tool (item 95320) Camarillo Calif. The current invention employs a similar component that is somewhat larger in overall length so it may employ a bit holder feature extending its functions.

The patent to Small, U.S. Pat. No. 273,621 bears some resemblance to the current invention. It is a multifunctional tool in which tools reside within the flute of a tapered wooden handle. The recesses terminate at the butt ends however.

Stillwagon, U.S. Pat. No. 3,667,518 discloses a handle that can carry tool bits that is very similar to the current invention. Our invention employs the use of O-rings as taught by Stillwagon. Our invention differs from Stillwagon in that bits are stored directly in the flutes—not in pockets formed within the flutes. As a result there is no limit on the length of the bit or accessory stored other than the length of the handle. The customizing of Stillwagon's tool for a particular set of tools dedicates the tool for that purpose. With our invention as needs change, different bits and or accessories may be stored to meet those needs. Additionally, because of the recessed pockets his design cannot be produced by extrusion. Furthermore, our handle has additional storage capacity and features over Stillwagon.

Lanfair U.S. Pat. Nos. 544,411 and 648,589 shows a holder for drills in which the tools are on a single bolt hole circle.

Wilcox, U.S. Pat. No. 2,337,514 discloses a complex tool handle, in which tools are stored in a recess and are accessed from the back of the handle.

Commercially available screwdrivers with storage capacity on a bolt-hole arrangement are known in the art. One example is a Wiha magnetic tip screwdriver which has a 6 hole, single row, bolt hole circle for bit storage. (cat. #06649602) available from MSC Industrial supply co. L.I. NY. The retaining cover on these units, serve no other purpose and the combination of bolt-hole array and flute storage doubles the tool-holding capacity.

### SUMMARY OF THE INVENTION

It is an object to provide a screwdriver blade with auxiliary driving means to access screws in tight quarters where conventional drivers can not be used.

It is an object to provide a tool that can engage a fastener with minimal overhead clearance.

It is an object to provide a tool with auxiliary driving means to produce more torque on a fastener than conventional screwdrivers

It is an object to provide a tool with a bit driver in the handle to provide more torque or to access a screw in limited space.

It is an object to provide a tool whose function as a regular screwdriver is not comprised.

It is an object to provide a tool with auxiliary driving means that can be produced at low cost.

It is an object to be able to provide auxiliary driving means by modifying existing screwdrivers.

It is an object to provide a tool with a bit driver in the blade of the shank to access fasteners in tight quarters and provide greater torque in conjunction with a Torrington ratcheting bit driver so as to run a fastener on or off without disengaging the tool.

It is an object to provide a tool that can turn a fastener on or off with as little as 30 degrees of permitted arc.

It is an object to provide a multipurpose tool that may be used as a file and a screwdriver.

It is an object to provide a tool with a non-conductive removable sleeve to insulate the user from electrical shock.

It is an object to provide a multipurpose tool that can perform as well or better than a single purpose tool.

It is an object to provide a multipurpose tool that can access screws in locations conventional tools cannot be used and to provide greater torque in conventional and non-conventional applications by means of auxiliary drivers.

It is an object to provide a multipurpose tool employing bit drivers that can carry an array of bits and accessories within the handle.

It is an object to reduce the number of tools to be carried or stored especially where weight and space are at a premium, this is especially valuable in troubleshooting where you might not know what tools will be required.

It is an object to provide a tool with as many functions as possible in a single self contained tool.

It is an object of the invention to provide a multi-function screwdriver that does not have the disadvantages of known screwdrivers.

It is another object of the invention to provide a multi-function screwdriver which is simple in construction and economical to manufacture.

It is still another object of the invention to provide a multi-function screwdriver that provides the conventional functions of a standard screwdriver and allows the driving of fasteners within a confined space that is a fraction of the dimensions of the overall length of the screwdriver.

It is yet another object of the invention to provide a multi-function screwdriver as in the previous objects which is provided on the outside surface of the handle with external axial channels or grooves for storing driver bits which are not in use.

Other objects and advantages will be apparent by referring to the detailed description of the invention.

### BRIEF DESCRIPTION OF THE DRAWINGS

FIG. 1 is a perspective view of the simplest embodiment of the invention partially exploded.

FIG. 2 is a perspective view of another embodiment of the invention partially exploded.

FIG. 3 is an end view of the screwdriver blade shown in FIG. 2, manufactured by machining.

FIG. 4 is an end view of the screwdriver blade in FIG. 2, manufactured by forging.

FIG. 5 is a cross sectional view of the bit carrier in FIG. 14 taken along lines a-a.

FIG. 6 is a fragmented side view of the handle driver of FIG. 2 partially in section.

FIG. 7 is a top elevation view of FIG. 6.

FIG. 8 is a perspective view of another version of the bit carrier used in the handle of FIG. 2.

FIG. 9 is a sectional view taken along lines x-x in FIG. 8.

FIG. 10 is a perspective view of another version of the bit carrier used in the handle in FIG. 2.

FIG. 11 is a fragmentary side view partially in section of another embodiment of the invention.

FIG. 11a is a fragmentary exploded isometric view of the embodiment in FIG. 11 with a bit driver shank.

FIG. 12 is a perspective view of the removable insulating sleeve used in the embodiment in FIG. 11.

FIG. 13 is a fragmentary top elevation view of the screwdriver shank in FIGS. 1 and 11 showing an auxiliary driver.

FIG. 14 is a top elevation view of the preferred bit carrier used in the handle of the embodiment in FIG. 2.

FIG. 15 is a top elevation view of another embodiment of the invention shown assembled but for 3 accessories.

FIG. 16 is an exploded view of FIG. 15

FIG. 17 is an end view of the back end of the handle shown in FIG. 16.

FIG. 18 is a fragmentary sectional view, along the centerline, of the back end of the primary auxiliary driver shown in FIG. 16.

FIG. 19 is an end view of the front face of the primary auxiliary driver showing magnetic retention means.

FIG. 20 is a perspective view of another version of stubby auxiliary driving means of FIG. 16.

FIG. 21 is a side view of an auxiliary driver insert bit adapted to hold jeweler's screwdriver blades.

### DETAILED DESCRIPTION OF THE INVENTION

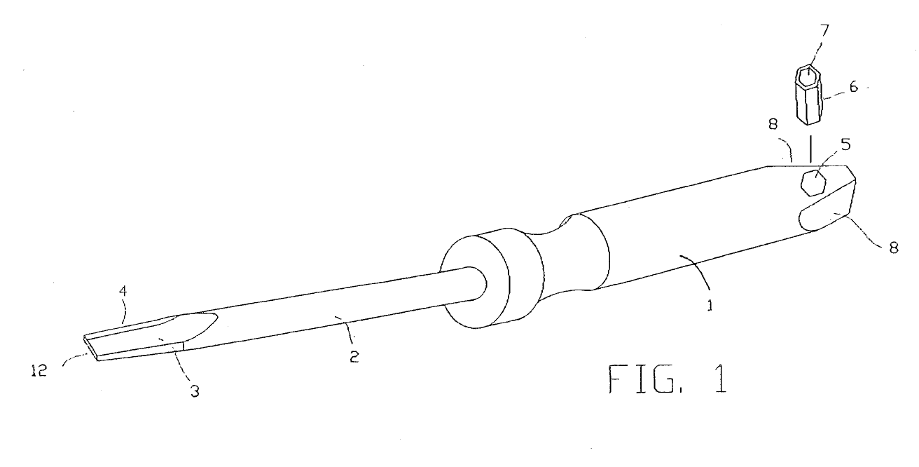

The simplest embodiment of the current invention is shown in FIG. 1. It consists of a screwdriver with a ergonomic handle 1 constructed from a suitable material such as plastic or aluminum and a fixed shank 2 whose exposed end is tapered 3 to engage a slotted spade style screw at the tip 12. Along the side edge an auxiliary relieved rib driver 4 is provided parallel with the axis by forging (for greatest strength); or by milling; or grinding. The use of this auxiliary driver produces more torque for tightening or breaking free a stubborn fastener or for accessing a screw in limited quarters. This represents a minimal footprint and can access a screw with the lowest overhead clearance. In addition, this is more economical to produce than the prior art which utilizes raised ribs that are generally more difficult to manufacture. Additionally, if the tip of the screwdriver needs to be reconditioned, the auxiliary driver can be renewed as well. This is not the case with much of the prior art. And in fact, the auxiliary driver feature can be provided by modifying an existing tool.

Disposed along the centerline in close proximity to the end of the handle is a noncircular aperture 5, preferably hexagonal. A metallic insert 6 is pressed or molded into the handle. The insert 6, also has a noncircular aperture 7, preferably ¼″ hexagonal. The hexagonal aperture 7 is tapered, produced by incomplete broaching, i.e. the broach does not pass completely through the part, and as a result, a tapered hexagonal form is produced. It is this shallow tapered form that enables the aperture to hold a bit securely within its confines against the force of gravity. Additionally, as the aperture is tapered, the tool bit will not be pushed through the tool when force is applied against a fastener. And as the aperture is open-ended, a bit which may become “stuck” can be knocked out from the opposite side. Angular flats 8 enables the tool to access a fastener in tight quarters especially in a corner. Any style of the ubiquitous ¼″ hex bits may be employed in the handle driver, spade, Phillips, Allen, torx, etc. Utilizing the auxiliary handle driver enables the tool to apply breaker-bar-like torque to a fastener with little more than 1″ of overhead clearance. It should be noted, bits may be installed in the hex aperture in any of three different positions (60 degrees), so that the bit can match the orientation of the slot in the fastener. Additionally, the aperture 7 in the handle may receive a bar to use the tool as a T or L handle, to apply greater torque when used in the conventional manner. The aperture, 7 may also be utilized for hanging the tool on a pegboard.

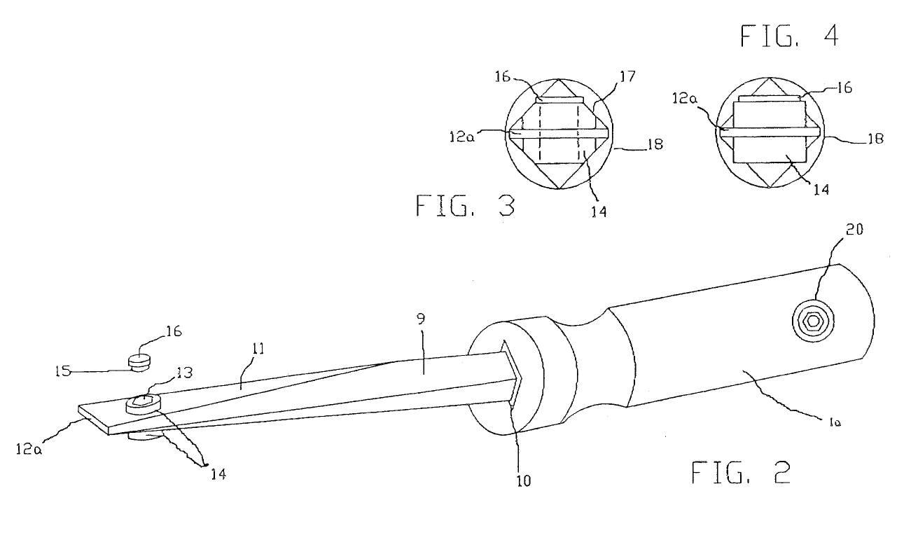

FIG. 2 represents another embodiment of the current invention. It has an ergonomic handle 1a and preferably a square shank 9 that may be either permanently affixed in handle 1a or that may be removably secured to the handle. The square shank 9 may be secured in a square blind broached hole directly in the handle if constructed of aluminum or, into a larger square insert 10, preferably constructed of steel, which may be pressed or molded into the handle, if constructed of plastic. Owing to its shape, the square shank cannot slip or rotate in the handle. Additionally, because of its shape, an open end wrench may be applied to the shank to produce more torque when the tool is used in the conventional manner.

The square shank 9 is tapered across the diagonal dimension of the square to form a spade style screwdriver 12a. In relatively close proximity to the tip 12a, a hexagonal aperture 13 is produced in tapered surface 11 of shank 9. The flats of the hexagonal opening, being oriented parallel to the axis of the shank. This, in essence, moves the auxiliary hex driver 7 in the handle of FIG. 1 to the screwdriver shank offering a lower profile than the handle and enabling it to get into tighter spaces. The concept was introduced in the previous patent application but, as shown, was not sufficiently developed to make it viable. Nor would Mulcays “wrench patent” U.S. Pat. No. 2,148,573 provide guidance to one skilled in the art, as to how to produce a torque resistant aperture in a narrow and relatively thin blade of a screwdriver. Further, he does not offer guidance as to how to securely retain a tool bit in the aperture, or how to keep the bit from pushing through the tool when it is applied to a fastener.

Shown at 14 is a circular boss on either side of the screwdriver which is preferably formed by forging or by selective machining. If machined, the corners of the boss 17 are “clipped” as shown in FIG. 3. Forging would produce a stronger component which may also have a larger dimension than that produced by machining (FIG. 4). Additionally, if boss 14 is produced by forging, it can be employed on a round shank as in FIG. 1. In either case the tool can still fit in a bore defined by the diagonal dimension of the shank 18. With this design it is possible to produce a viable ¼″ hexagonal aperture in a ⅜″ square shank with a blade that can be tapered down sufficiently so that it can accommodate a #10 screw. The wall thickness of the boss 14 compares favorably with the wall thickness of a conventional ¼″ socket. Bit retention may be accomplished by producing a taper in hexagonal aperture 13 as with handle driver 7. However, since the length of the blade driver is relatively short, this will only work with precisely sized bits. In addition, controlling the dimension 13 precisely is difficult, especially as the part can change dimension with heat treatment.

The preferred method of holding bits, is by magnetic retention. In this case the hexagonal cross hole 13 is not tapered, and a rare-earth magnet is employed. A disc magnet 15 smaller than aperture 13 is secured in a nonmagnetic carrier 16 by either press fit or Loctite™ into a spot faced bore in carrier 16. For this application, it is dimensioned such that the face of the magnet protrudes from the face of the carrier. At least a portion of carrier 16 is slightly larger than the hexagonal aperture 13 and the assembly is pressed in place-permanently securing same, and making the aperture 13 into a blind hole.

The use of the hexagonal bit driver in the shank offers compelling advantages over all the prior art that utilize auxiliary driving means in the screwdriver blade. Bits of any style (Phillips, spade, Allen, etc) may be employed in the tool. With the prior art, a separate tool would be required for each style driver but the majority of the prior art is restricted to spade type bits for slotted type screws. Additionally, fixed auxiliary drivers lack versatility, in that there are times a very low profile is required, where there is little overhead clearance, and there are times in which a longer extension may be required to clear obstructions. With the current invention one may simply employ the appropriate bit for the job, and for an ultra-low profile, a modified “sawed” off bit can be used. The lower profile means the tool would work where most of the prior art could not fit. Troy and Tascone teach low profile auxiliary drivers but they are confined to slotted screws. In addition Tascone's tool is not suitable for a countersunk flat head screw.

Furthermore, most of the prior art multi-head drivers are unsuitable for using the tool in the conventional fashion to access a screw in a corner or in a counter-bored hole due to there enlarged heads.

As there are instances in which the screwdriver can only rotate through a portion of an arc, and as a slotted screw may be found in any given orientation the prior art employs multiple drivers at different orientations such that a fastener can be turned requiring only 90 degrees, or in one case 45 degrees of arc. With the current invention, matching the orientation of the screws slot is accomplished by inserting the bit in any of three positions for 60 degrees of arc. If one employs a bit manufactured with the slot indexed parallel to the flat and another with the slot indexed to the diagonal, then by alternating bits and index positions, a fastener can be installed or removed with only 30 degrees of permissible rotation. This is less than any of the prior art.

In addition, the current invention could be manufactured more economically than most of the prior art multi-head drivers. And further, when such tools become worn or damaged, it would be difficult or impossible, and limited at best, in the ability to renew the tool. In the case of the current invention when the tool bit becomes worn it can simply be discarded and replaced with a new one. Finally, another advantage to moving the bit driver to the screw driver shank is that the handle may now incorporate a ratchet. Thus the hexagonal blade aperture can be used to break the fastener free and the ratchet member used to run the fastener off without repositioning the tool. This is a significant advantage, when space permits, eliminating the tedious constant repositioning and re-engagement of the bit described earlier.

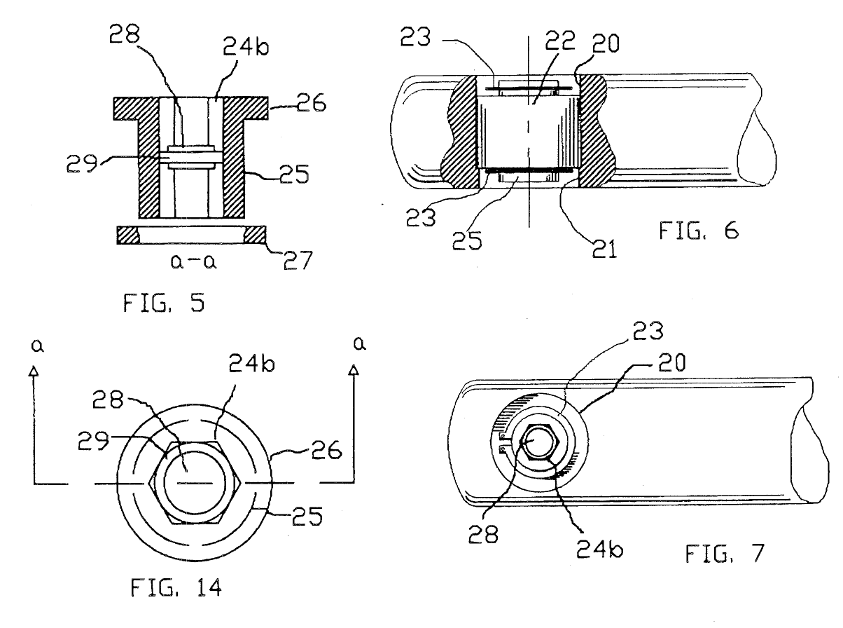

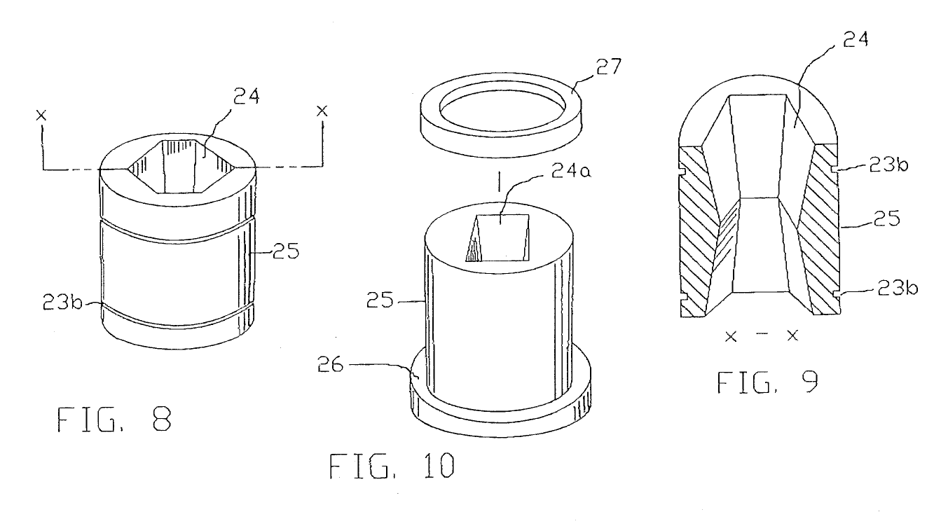

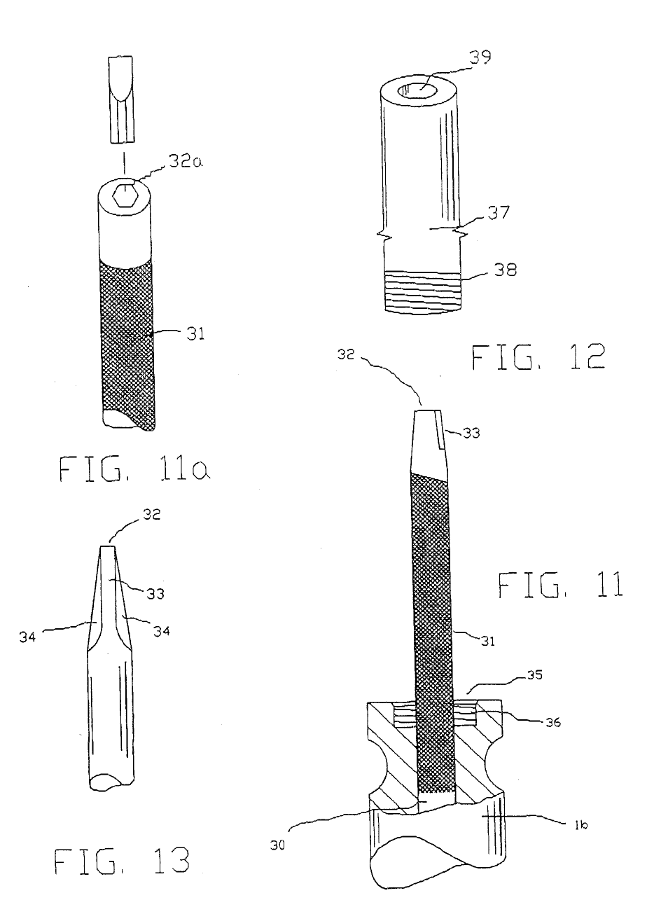

Located at the rear of the handle on the centerline is a cross hole 20 (FIGS. 2,6,7). The cross hole may have a step in it 21 (FIG. 6) to act as a stop, facilitating the centering of a Torrington roller slip clutch 22 which is pressed into cross hole 20. The roller slip clutch is commercially available (Small Parts, Miami Lakes Fla.). The assembly functions as a ratchet permitting rotation in one direction only. The use of this “cartridge” has advantages over the prior art in that only a cross hole is required to implement it and it operates with a lesser degree of arc than the pawl and tooth design. Inserted into slip roller clutch 22 is a bit carrier 25 that has a precisely sized preferably hardened cylindrical body into which is formed a noncircular, preferably hexagonal aperture 24, 24a, 24b. The cylindrical body 25 may have snap ring grooves 23b machined in it at either end to retain the bit carrier in roller clutch 22 by means of snap rings 23. The bit carrier 25 may instead preferably be constructed with a head 26, instead of a snap ring which will facilitate the broaching operation as well as retaining the part. In this case, the carrier 25 is retained by means of a press fit ring 27 which is forced onto the carrier 25, when installed in roller clutch 22 with an arbor press. This results in a stronger part. One means of retaining a bit in the bit carrier is by producing a taper in the aperture as seen in FIG. 9. This will cause the bit to jam in the taper. The taper is produced from both sides as it is necessary to install the bit in one side for clockwise rotation and the other for counterclockwise rotation.

The preferred means for retaining bits in carrier 25 is shown in FIG. 5. This carrier has a hexagonal aperture 24b that has no taper. Instead, a rare-earth magnet 28 is press fitted or glued into a nonmagnetic ring 29 which in turn is press fitted or glued centrally into the aperture 24b permanently securing the assembly. The ring 29 is thinner than the magnet so that the magnet face protrudes from either end of the ring. Thus a bit may be inserted into either end of the bit carrier 25 and be held magnetically. This design holds bits securely and is tolerant of bits that vary in size, holding bits with consistent force, without being too difficult to remove. Additionally, through broaching of the part facilitates production of the component.

FIGS. 11 and 12 shows an embodiment of the tool adapted to the needs of electricians. The handle 1b is constructed from an insulating material such as polycarbonate or other suitable plastic. The screwdriver shank 30 is securely pressed or molded into the handle 1b. The shank 30 has a section 31 that is a file and may be round, square, or triangular in cross section. The end portion 32 of the shank 30 is tapered to form a spade type screwdriver blade. An auxiliary driver 33 (FIGS. 11,13) may be formed by grinding or milling to relieve the blade at 34 so that auxiliary driver 33 may engage screws with the screwdriver on its side to produce more torque or to gain access to a screw in limited quarters. The shank 30 may terminate into a Philips type bit at its end 32 instead. A preferred alternative, however, is a fixed file shank which terminates with a bit driver 32a as seen in FIG. 11a, so that the user may select from an array of bit drivers. A cylindrical shank is shown, but other profiles may be used. Bits may be secured magnetically, using the same means as shank 60 (FIG. 19). Formed in handle 1b is a female recess 35 which is internally threaded 36 to receive an electricity insulating nipple or sleeve 37 which has male threads 38 that engages and cooperate with female threads 36 in handle 1b. Removable nipple 37 has an axial center through-hole 39 to clear the screwdriver shank. It is a relatively close clearance fit for the diametrical profile of shank portion 31. The purpose of the sleeve 37 is to insulate the user from electrical shock if the tool accidentally contacts live wires and to prevent shorting out the circuit. The sleeve, like a knife sheath, protects the user, his pocket, and the tool from damage when not being used for its intended purpose. It is removable to access the file shank, and for use in very tight quarters on non-electrical applications where it could interfere with the operation of the tool. In addition, the sleeve may be used as an anchoring point for a rag draped over the tip of the shank so that the screwdriver may be used as a pipe swab to remove residual oil inside of pipes after having machined threads on them.

In another embodiment shown in FIG. 15 the handle 1c has a series of flutes or channels 1d that extend the length of the handle, to store bits or accessories. The bits are retained in the handle by means of elastomeric O rings 45 that sit in O ring grooves machined in the handle. They are typically spaced to accommodate 1″ long ¼″ hexagonal bits. The channels 1d are preferably U shaped for maximum density. The optimum dimension of the channels should be ¼″ deep by 9/32″+0.005″ wide so bits fall out easily. The profile of a 9/32″ ball end mill produces the desired shape. Our invention utilizes O rings to retain bits in the handle as taught by Stillwagon U.S. Pat. No. 3,667,518. However, the subtle patentable distinction between Stillwagons patent and the current invention is that bits are retained directly in the U-channel. In Stillwagons patent, bits are retained in pockets machined or molded for specific length tools. With our tool there is no restriction on the length of the tool that can be held other than the length of the handle. In addition, once Stillwagons tool is customized for a particular set of tools, it is essentially dedicated for that purpose. In our invention, one can mix and match bits and accessories for their needs, and as needs change they can change the mix of tools stored.

Another improvement over Stillwagon is shown in FIG. 17. This is the use of longitudinal ribs 99 on the lands of the handle 1c between the bit channels 1d. The raised ribs run the length of the handle and they have a radius profile. Only two ribs are shown, but they would typically be used on all the lands. The ribs improve the users grip on the tool, and they serve to better retain the O ring. When displacing the O ring to remove a bit, it would sometimes dislodge the adjacent bit(s). The ribs seat the O ring deeper and change the dynamics of the O ring displacement into more of a U than an arc so the adjacent bit remains in its place.

Additional storage capacity by our invention over Stillwagon is achieved by a plurality of holes 46, 54 in the back face of the handle 1c shown in FIG. 17. As shown, the handle has 6 equally spaced channels 1d and six holes 46 on a bolt-hole circle offset 30 degrees from the channels. The arrangement resembles the cylinder of a revolver type pistol. A further advantage of this design over Stillwagon is that it can be made by extrusion, including the holes, and the ribs 99 greatly reducing secondary machining operations.

The arrangement shown can be done on a large handle approximately 1⅜″ in diameter. With a handle approximately 4¾″ in length 4 one inch bits can be stored per channel. If the handle uses a fixed shank, then the bolt hole circle holes 46 can store an additional 4 bits/hole for a storage capacity of 48 bits. If a larger removable shank 60 is used, then the bolt holes 46 are stepped holes 47 and they store one slim shank bit per/hole (typically Allen key style bits). If the bolt holes are eliminated, then 8 channels could be made on a 1⅜″ diameter handle. Or, it should be noted a lesser number of channels may be used and several channels may be larger in size—for example ⅜″ or ½″ channels to store non-conventional accessories. This actually proves more useful than the ability to store bits alone. An unconventional item one may wish to store for example is an LED keychain type mini flashlight 48 which can be stored in a 10 mm channel as shown in FIG. 15. It turns the screwdriver into an illuminated tool for work in dark areas.

Referring to FIG. 17, the back end of the handle 1c also has a center counter-bored hole 50 which has a central steel stud 51 which may be hexagonal as shown, for torque transmission, or round, for free spinning swivel action of stubby member 49. Central stud 51 may have a hole in its center 52. The stud 51 projects a precise distance from the bottom face 53 of counter-bore 50. The counter-bore and stud are sized to receive stubby auxiliary driver 49. Alternatively, instead of a steel stud at 51 it may instead be a female blind broached hexagonal hole. A ¼″ Allen bit 65 is inserted and retained in stubby driver 49 at 56. The assembly is inserted in counter-bore 50 until hex key 65 engages what is now a hexagonal aperture 51. The assembly is held in place by a friction fit with secondary cover sleeve 73.

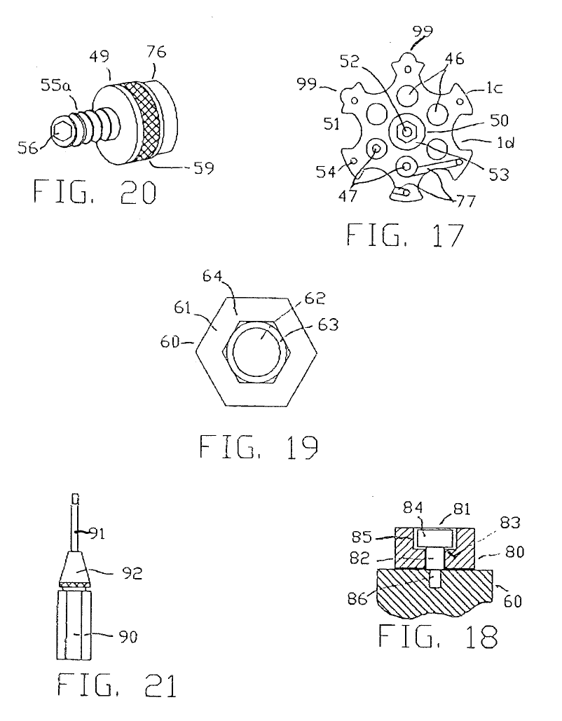

The turned down section 55 of stubby driver 49 has a blind center drilled hole that is blind broached 56 (best seen in FIG. 20) to receive a ¼″ hexagonal bit such as at 57. The bit is retained in the stubby driver in a manner that is the same as the bit retention means of primary driver 60, best seen in FIG. 19 in which a rare earth disc magnet 62 is mounted in a non-magnetic carrier which may be hexagonal or cylindrical as shown at 63 The magnet 62 is press fitted or Loctited™ into a spot faced seat in carrier 63. The magnet may project above the face of the carrier, or in cases where the tool will be hammered, it may be slightly recessed. The assembly is then press fitted or Loctited™ into the hexagonal center broached blind hole 64. This permanently retains the assembly so it will not come out when the bit is pulled out of the tool.

Stubby member 49 serves a number of functions. First, it is an independent auxiliary screwdriver for use in tight quarters. Secondly, it acts as a cover to retain stored bits in the back of the handle 46, 54. In addition, the stubby member 49 has a cross hole 58 thru the large knurled diameter 59. This is an incompletely broached hexagonal hole that has a slight taper in its form. This serves as a means to retain ¼″ hex bits or accessories as the bit will jam in the taper. The cross hole 58 may also be used to hang the tool up. The primary function of cross hex-hole 58 in stubby member 49 is a means for applying substantial additional torque to a fastener in a number of manners. First, a bit can be inserted in cross-hole 58 with the tool assembled as in FIG. 15. In this case, the tool is used-“backwards” grabbed from the shank end to apply breaker-bar like torque to a fastener. It should be noted that as the cross hole 58 is located in the stubby at the rear of the tool, that this is the most advantageous position, so that it can engage a fastener in limited space. Additionally, Stubby member 49 can be placed in bit extension 71 by means of a ¼″ hex key bit 65 substituted for bit 57 in aperture 56. In this case one grasps the handle 1c and applies right angle torque to a fastener with the desired bit in cross-hole 58 or vice versa. Additionally, stubby member 49 may be employed to provide increased torque to the screwdriver when the tool is used in the conventional manner. In this case, turned down shank 66 is inserted into hexagonal cross hole 58 with the tool assembled as in FIG. 15. If the hexagonal portion 66 is inserted into cross-hole 58 it becomes an L handle for applying maximum torque. If the turned down portion 67 is inserted into cross hex-hole 58 it becomes a T handle for balanced torque. Shank 66 is dimensioned so the cylindrical portion freely passes thru hex-hole 58 and its length is such that when the hex portion jams in cross-hole 58, an equal length projects from either side of stubby member 49.

In addition to being a T or L handle the hex portion 66 of the turned down shank may be inserted into extension 71 or primary driver 60 to provide a long length shank. The end of the turned down shank forms a spade type screwdriver bit 68. The shank may of course terminate with a different driver type—Philips for example.

It should also be noted that the long end of a ¼″ Allen key 72 may be inserted into cross hole 58 when assembled as in FIG. 15 and it becomes a J speed handle for cranking a long fastener.

Stubby member 49 may be constructed of hard-coated aluminum, titanium, or a steel/aluminum composite with segment 55 and cross-hole 58 being a hexagonal steel insert. Shown at 73 is a secondary end cover which may be made of plastic such as polyethylene or, possibly an elastomer. The bore 74 is a slight press fit for turned diameter 55 of stubby member 49. The turned diameter 75 is a mild push fit for counter-bore 50. Secondary cover 73 is used to retain bits in the back of the handle 46, 54 when stubby driver 49 is being used as an independent screwdriver.

It is also possible to secure stubby driver 49 to the handle 1c by threading turned diameter 55 producing male threads 55a FIG. 20. Counter-bore 50 is likewise threaded to accept threads 55a. In this application, stubby member 49 has a hardened steel cap 76 pressed into the back of the knurled head 59. This is used for hammering applications, for example, using a ¼″ hexagonal cold chisel in primary driver 60. Alternatively, cap 76 may be plastic and the tool used as a thumper.

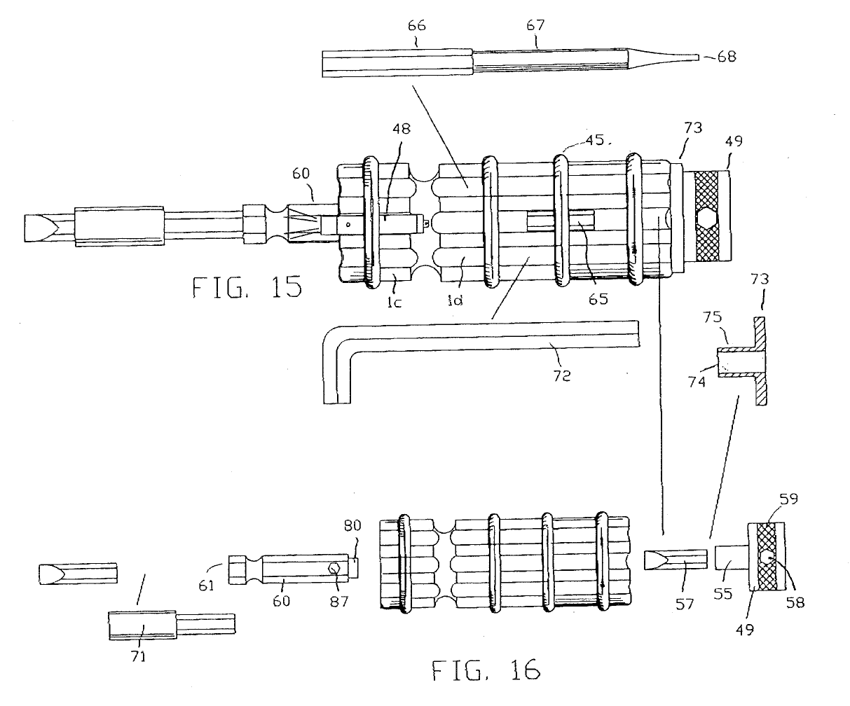

What would be considered the shank of the screwdriver is seen at 60. The face 61 of the primary driver has a blind female hexagonal aperture into which a rare-earth magnet assembly 62/63 is pressed or otherwise secured as described previously. ¼″ hex bits may be secured directly in shank driver 60 or in an extension 71, (prior art) thus resulting in a variable length shank. It should be understood that the primary driver shank may be of a smaller diameter permanently fixed arrangement in handle 1c or it may be detachable as shown in FIG. 16. In this case, primary driver 60 is itself hexagonal and is secured in a center blind broached female hexagonal aperture in handle 1c. The retention means is not unlike that shown in FIG. 19 except that a larger, stronger magnet is used to secure the shank 60 so that when bits are changed from face 61 the shank 60 remains in place in handle 1c. The disc magnet in handle 1c retains shank 60 thru steel swivel 80 that is secured to shank 60 by a shoulder pin 81 which is pressed into shank 60. The length of the shoulder 82 on shoulder pin 81 is slightly longer than the depth of stepped-hole 83 in swivel 80. The head 84 of shoulder pin 81 retains the swivel 80 by counter-bore 85. Pin section 86 is press fitted into shank 60.

It will be noted, that shank 60 is itself an independent screwdriver, useful for delicate work where handle 1c would be too cumbersome. The swivel member 80 allows the tool to be used like a jeweler's screwdriver. At the rear of shank 60 is a taper broached non-round hexagonal aperture 87 so that the divorced driver may employ the same advantages as the embodiment in FIG. 1. As primary driver 60 is hexagonal an open end or box end wrench may be applied to the tool, giving the user another option to produce significantly more torque on a fastener, and since its is hexagonal it permits the use of a box end wrench which will not slip off the tool.

Shown in FIG. 21 is a ¼″ hex bit 90 adapted to holding a jewelers screwdriver blade 91. A knurled knob 92 is used to removably secure the blade. Since this arrangement is standardized it is not necessary to store numerous assemblies. Instead only one assembly 90 need be stored, and the individual jeweler's blades may be installed in assembly 90 as needed. These bits are typically used in primary driver 60 divorced from handle 1c. In cases where space is limited insert assembly 90 may be used itself as an independent screwdriver. The individual jeweler's blades may be stored in 7/64″- 9/64″ holes 52, 54 in the back of the handle 1c on the same index position as holes 46 but on a larger bolt-hole circle. Alternatively, or in addition to, storing jeweler's blades, small diameter Allen keys may be stored in holes 54. The holes 46, (47), 54, would be plugged by any suitable means at the other end of the handle. Thirteen jeweler's screwdriver blades or six Allen keys and 7 jeweler's blades may be stored in these holes. Channels 77 may be milled in the back face of handle 1c connecting with holes 54 to seat the short leg of the Allen key. Stepped holes 47 are used with the removable shank 60 version of the tool. They are used for the storage of hex bits having extended slim shanks such as Allen keys. These are typically used with divorced shank 60. This effectively overcomes the only real disadvantage of insert style screwdrivers—for small work the body of the bit holding shank is too large and simply can't get down into small bores.

If the embodiment shown in FIGS. 15, 16 is fully tooled (and four bits are substituted for Allen key 72) the tool can perform an enormous number of functions—depending on how functions are counted it can exceed 200 uses.

This would include:
19 short length screwdrivers
19 regular length screwdrivers (with extension 71)
1 (19) illuminated screwdrivers
1 extended length spade shank
1 extra length slotted spade shank (with ext 71)
19 T handle screwdrivers
(19) L-handle screwdrivers
19 breaker bar driver
19 breaker bar extensions (with ext 71)
24 stubby screwdrivers
6 Allen keys
25 mini screwdrivers (60)
25 T handle mini drivers
25 mini breaker bars
7 Stub length jeweler's screwdrivers (90)

Regardless as to how many functions the tool may accomplish we know of no other single, self contained tool in the prior art that approaches the number of functions this tool can perform.

While the embodiments shown constitute the preferred embodiments of the invention it should be understood that changes may be made without departing from the scope and spirit of the invention, for example features may be swapped or omitted between the embodiments shown, for particular applications, and a fixed or detachable shank may be utilized. The invention should not be considered limited except by the defining claims.

1. A screwdriver having an elongate handle generally defining an axis; a substantially uniform elongate shank arranged along said axis and having one end embedded within said handle and defining a cylindrical surface and having another end provided with a driver tip arranged within a cylindrical envelope defined by said cylindrical surface and configured for engaging and driving a fastener by rotating the fastener about an axis, substantially coextensive with said handle axis, and auxiliary driver means arranged within said cylindrical envelope for driving a fastener about an axis substantially normal to said handle axis.

2. A screwdriver as claimed in claim 1, wherein said auxiliary drive means comprises a tip on a flat blade screwdriver tip which reduces the thickness of at least one lateral edge of the flat blade tip to a dimension suitable for insertion into the slot of a straight-slotted fastener.

3. A screwdriver as claimed in claim 2, further comprising, a generally straight raised land or ridge on a primary face of the flat blade tip that extends in a direction generally normal to a direction of said milled lateral edge.

4. A screwdriver as claimed in claim 1, wherein said shank is knurled to also function as a file.

5. A screwdriver as claimed in claim 1, further comprising an insulating sheath for selectively covering said shank.

6. A screwdriver as claimed in claim 5, further comprising securing means for selectively attaching said sheath to said handle to prevent inadvertent separation.

7. A screwdriver as claimed in claim 6, wherein said securing means comprises a recess in said handle, at said embedded end, provided with an internal thread, and an externally threaded end of said sheath that can threadedly mesh with said internal thread.

8. A screwdriver as claimed in claim 1, wherein said auxiliary driver means comprises a bit driver.

9. A screwdriver as claimed in claim 8, wherein said bit driver comprises an opening on a portion of the screwdriver, said opening including bit retaining means for securing a bit driver within said opening during normal bit driving operations.

10. A screwdriver as claimed in claim 9, wherein said opening is formed in said handle.

11. A screwdriver as claimed in claim 9, wherein said opening is formed in said driver tip.

12. A screwdriver as claimed in claim 8, wherein said bit driver includes a clutch and is ratcheted.

13. A screwdriver as claimed in claim 8, wherein said bit driver is fixed.

14. A screwdriver as claimed in claim 9, wherein said opening forms a tapered channel to prevent a bit from fully passing through said opening, and retains a bit by frictional or pressure fit or engagement.

15. A screwdriver having an elongate handle generally defining an axis, an elongate shank arranged along said axis and having one end embedded within said handle and having another end provided with interchanging means for selectively interchanging generally elongate driver tips, said handle being provided with at least one axial elongate substantially uniform surface channel generally parallel to and extending along a substantial length of said handle along said handle axis and dimensioned for receiving at least one driver tip when not in use; and retaining means for retaining at least one driver tip within said at least one channel to prevent inadvertent separation of said at least one retained driver bits.

16. A screwdriver as claimed in claim 15, wherein a plurality of channels are provided spaced about said handle.

17. A screwdriver as claimed in claim 15, wherein said retaining means comprise at least one elastic band.

18. A screwdriver as claimed in claim 17, wherein a plurality of elastic bands are provided spaced for each along a direction parallel to said axis.

19. A screwdriver having an elongate handle generally defining an axis; an elongate shank arranged along said axis and having one end embedded within said handle and having another end provided with a driver tip configured for engaging and driving a fastener by rotating the fastener about an axis, substantially coextensive with said handle axis, and auxiliary driver means for driving a fastener about an axis substantially normal to said handle axis; an insulating sheath for causing a substantial portion of said shank between said ends; and securing means for selectively securing said sheath to said handle during use to prevent inadvertent separation.

20. A screwdriver as claimed in claim 19, wherein said securing means comprises a recess in said handle, at said embedded end, provided with an internal thread, and an externally threaded end of said sheath that can threadedly mesh with said internal thread.
